(19) United States
(12) Patent Application Publication
(10) Pub. No.: US 2002/0171164 A1
(43) Pub. Date: Nov. 21, 2002

(54) Process and apparatus for making a thermoset foam

(76) Inventors: Steve Halterbaum, Highlands Ranch, CO (US); David G. Wernsing, Littleton, CO (US)

Correspondence Address: JOHNS MANVILLE INTERNATIONAL, INC., Legal Department, P.O. Box 5108, Denver, CO, 80217, US

(21) Appl. No.: 09/855,895

(22) Filed: May 15, 2001

(51) Int. Cl. B29C 44/20; B29C 44/28

(52) U.S. Cl. 264/53; 264/166; 264/211; 264/211.23; 264/211.24; 425/4 C; 425/89; 425/224

(57) ABSTRACT

A thermosetting foam, preferably a polyurethane foam is prepare by mixing all the components in one or more extruders and directing the chemical streams to a mixing head where the catalyst is added. Thus, the reaction can be controlled in a facile manner, whereby clogging of the extrusion head is avoided.

### BACKGROUND OF THE INVENTION

1. Field of the Invention

The present invention relates to a method and apparatus for the manufacturing of thermosetting foams. In particular, it relates to the continuous manufacturing of a polyurethane or polyisocyanurate foam.

2. Description of Related Art

Foamed synthetic resins such as polyurethane find wide-spread use in a variety of products such as bedding (e.g., mattresses, pillows), furniture and automotive upholstery, thermal and sound installation, and the like. In the manufacture of thermoset foams and specifically polyurethane or polyisocyanate foams a polyol, isocyanate, blowing agent, fillers, and at least one catalyst are mixed to form a reacting chemical liquid which then foams and solidifies to produce a solid polyurethane or polyisocyanate foam.

It is well known in the art of thermosetting foams that the process of making polyisocyanurate or polyurethane foams, the reaction is exothermic. However, the reaction rate is controllable based on the temperature at which the reaction takes place. The foaming reaction is described as having a “cream time,” during which foaming is initiated and the material reaches a consistency of a creamy foam, and a “firm time” at which the foam sets up and hardens. Typically, the “cream time” is between 2 and 12 seconds and the firm time may be between 8 to 20 seconds.

Continuous processes for the manufacture of foams have been considered where the reactive ingredients are metered and mixed in an extruder. Subsequently, the extruded polymeric material is place onto a conveyor, such as the one discussed above, where the foam expands and cures in the desired shape. In prior attempts to extrude thermosetting resins, extrusion has had a limited success because the reaction mechanism is difficult to control within the extruder. Where the reaction mixture has “creamed” and/or foamed within the extruder, it has blocked the die, and thus prevented extrusion.

In U.S. Pat. No. 3,466,705 to Richie, an apparatus for extruding foamable thermoplastic material, such as polystyrene, is discussed. Richie discloses that the apparatus may be employed for thermosetting foams, however, the employment of steam or hot water would have a deleterious effect on the foam. U.S. Pat. No. 5,723,506 to Glorioso et al, which is hereby incorporated herein by reference in its entirety, describes the extrusion of thermosetting foams, and particularly polyisocyanurate or polyurethane foams. In the type of system discussed therein, the reactive ingredients, including the catalyst are introduced into the extruder and the reaction is controlled by water cooling of the extruder barrel. Nonetheless, it is difficult to accurately control and prevent the formation of creaming which ultimately leads to clogging of the extruder head.

To meet the requirements of the thermoset foam manufacturing industry and to overcome the disadvantages of the related art, it is an object of the invention to provide a novel apparatus and method for the fabrication of thermoset foams, wherein the reaction mixture is prepared in an extruder and the catalyst is added thereafter, so as to control the rate of reaction.

It is another object of the present invention to provide a mixing head to which the reaction mixture from the extruder is conveyed and thereafter mixed with the catalyst. The reaction mixture from the extruder may be metered via a metering pump to the mixing head.

It is yet another object of the present invention to prepare the polyol master batch and isocyanate in separate extruders and then feed the chemical streams to a mixing head.

It is a further object of the present invention to employ a twin-screw or reciprocating screw extruders to prepare the reaction mixture.

Other objects and aspects of the present invention will become apparent to one of ordinary skill in the art upon review of the specification, drawings and claims appended thereto.

### SUMMARY OF THE INVENTION

In accordance with the invention it has been determined that a thermosetting foam can be fabricated by mixing all the components in one or more extruders and directing the chemical streams to a mixing head where the catalyst is added. Alternatively, one could also add catalyst to the polyol side which is then fed to the mixing head. Thus, the reaction can be controlled in a facile manner, whereby clogging of the extrusion head (i.e., die) is avoided.

According to one aspect of the invention an apparatus for continuously manufacturing a thermoset polymer foam is provided. The apparatus includes:

at least one extruder for metering at least one chemical stream;

a mixing head for continuously receiving and mixing at least two chemical streams, at least from the extruder;

a conduit connected to the mixing head to supply a metered amount of catalyst; and

a conveyor disposed below to receive a substantially homogeneous reacting chemical liquid from the mixing head, wherein the conveyor includes a frame defining a mold.

In accordance with another aspect of the invention, a method for continuously preparing a thermosetting polymer foam is provided. The method includes:

introducing polyol into an extruder barrel;

introducing an isocyanate into the extruder barrel;

introducing filler particles into the extruder barrel;

introducing a foaming agent into the extruder barrel;

mixing the polyol with the isocyanate, the filler particles and the foaming agent in the extruder to form a chemical mixture;

metering and supplying the chemical mixture to a mixing head; and

introducing a catalyst to the mixing head, thereby reacting the isocyanate and polyol and initiating a foaming reaction.

### BRIEF DESCRIPTION OF THE DRAWINGS

The objects and advantages of the invention will become apparent from the following detailed description of the preferred embodiments thereof in connection with the accompanying drawings, in which:

FIG. 1 is a schematic diagram of a foam processing apparatus for fabricating a polymer foam on a conveyor.

FIG. 2 is a schematic diagram of a foam processing apparatus for an integrated process including preparation of a polymer premix prior to extrusion.

FIG. 3 is a schematic diagram of an apparatus for an integrated process wherein the components are added at different mixing zones on the extruder.

### DETAILED DESCRIPTION OF THE PREFERRED EMBODIMENTS OF THE INVENTION

The invention provides an effective manner of controlling the reaction rate of the isocyanate with the polyol, through the addition of the catalyst downstream of the extruder, thus initiating the foaming reaction at that location.

As used herein, the terms “reacting chemical liquid” and “reaction mixture” refer to both the isocyanate and polyol in combination with the catalyst and optionally other components which may be added to a polyurethane foam (i.e., blowing agent, filler, surfactant, etc.).

An extruder is utilized to enhance the dispersion of the polymer mixture. Suitable extruders include single-screw extruders, twin-screw extruders, as well as reciprocating screw extruders, which mix and homogenize materials needed to manufacture thermosetting polymers. Preferably, a twin-screw extruder with multiple mixing sections is used and operated at a screw speed of about 300-900 rpm, and more preferably about 600-800 rpm. Speeds may be 1,000 rpm or higher.

It is common practice in the manufacture of rigid polyisocyanurate foams to utilize two preformulated components, commonly called the A-component and the B-component. Typically, the A-component contains the isocyanate compound that must be reacted with the polyol of the B-component to form the foam, and the balance of the foam-forming ingredients are distributed in these two components or in yet another component or components.

In accordance with one aspect of the invention a thermoset foam is fabricate by supplying the foam components, except the catalyst, to an extruder to mix and homogenize the chemical stream. Particularly, the isocyanate (A-component), polyol (B-component), blowing agent and optionally surfactants and fillers are added in a metered amount into the extruder. Catalyst is separately supplied from reservoir to a mixing head in a predetermined amount to initiate the foaming reaction. The foaming mixture is discharged from the mixing head onto a conveyor. The foam is allowed to rise and cure as the structural cells are formed. The product is then removed downstream where secondary operations are performed.

In the broadest aspects of the present invention, any organic polyisocyanates can be employed in the preparation of the rigid polyisocyanurate foams. The organic polyisocyanates which can be used include aromatic, aliphatic and cycloaliphatic polyisocyanates and combinations thereof. Such polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, all of which are incorporated herein by reference.

Representative of the polyisocyanates are the diisocyanates such as m-phenylene diisocyanate, toluene-2,4-diisocyanate, toluene-2,6-diisocyanate, mixtures of 2,4-and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, 2,2′-2,4′- and 4,4′-diphenylmethane diisocyanate, polymethylene-polyisocyanates (polymeric MDI), 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4′-triphenylmethane-triisocyanate, toluene-2,4,6-triisocyanate; and the tetraisocyanates such as 4,4′-dimethyldiphenylmethane-2,2′,5,5′-tetraisocyanate.

Prepolymers may also be employed in the preparation of the foams of the present invention. These prepolymers are prepared by reacting an excess of organic polyisocyanurate or mixtures thereof with a minor amount of an active hydrogen-containing compound as determined by the well-known Zerewitinoff test, as described by Kohler in “Journal of the American Chemical Society,” 49, 3181 (1927). These compounds and their methods of preparation are well known in the art. The use of any one specific active hydrogen compound is not critical hereto, rather any such compound can be employed herein.

Preferred isocyanates used according to the present invention include Mondur 489 (Bayer), Rubinate 1850 (ICI), Luprinate M70R (BASF) and Papi 580 (Dow). Isocyanate indices from about 150 to about 400 are preferred.

In addition to the isocyanate, the foam-forming formulation also contains an organic compound containing at least 1.8 or more isocyanate-reactive groups per molecule. Preferred isocyanate-reactive compounds are the polyester and polyether polyols. Such polyester and polyether polyols are described, for example, in U.S. Pat. No. 4,795,763.

The polyester polyols useful in the invention can be prepared by known procedures from a polycarboxylic acid or acid derivative, such as an anhydride or ester of the polycarboxylic acid, and a polyhydric alcohol. The acids and/or the alcohols may, or course, be used as mixtures of two or more compounds in the preparation of the polyester polyols.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester. Still other preferred materials containing phthalic acid residues are polyalkylene terephthalate, especially polyethylene terephthalate (PET), residues of scraps and by-product terephthalate acid streams. Other preferred residues are DMT process residues, as discussed in U.S. Pat. No. 5,605,904.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms are highly satisfactory. The polyols optionally may include substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include: ethylene glycol; propylene glycol-(1,2) and -(1,3); butylene glycol-(1,4) and -(2,3); hexane diol-(1,6); octane diol-(1,8); neopentyl glycol; 1,4-bishydroxymethyl cyclo-hexane; 2-methyl-1,3-propane diol; glycerin; trimethylol-propane; trimethylolethane; hexane triol-(1,2,6); butane triol-(1,2,4); pentaerythritol; quinitol; mannitol; sorbitol; formitol; α-methyl-glucoside; diethylene glycol; triethylene glycol; tetraethylene glycol and higher polyethylene glycols; dipropylene glycol and higher polypropylene glycols as well as dibutylene glycol and higher polybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Particularly preferred polyester polyols include Stepanpol PS2352 (Stepan) and Terate 2541 (Hoechst Celanese). Preferred amounts of the polyester polyols are consistent with isocyanate indices of 150 to 400.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

Any suitable blowing agent can be employed in the foam compositions of the present invention. In general, these blowing agents are liquids having a boiling point between minus 50° C. and plus 100° C. and preferably between 0° C. and 50° C. The preferred liquids are hydrocarbons or halohydrocarbons such as chlorinated and fluorinated hydrocarbons. Suitable blowing agents include hydrochloro-fluorocarbons such as HCFC-141b (1-chloro-1,1-difluoro-ethane), HCFC-22 (monochlorodifluoromethane), HFC-245fa (1,1,1,3,3-pentafluoropropane), HFC-134a (1,1,1,2-tetra-fluoroethane), HFC-365mfc (1,1,1,3,3-pentafluorobutane), cyclopentane, normal pentane, isopentane, 2-chloro-propane, trichlorofluoromethane, CCl₂FCC1F₂, CC1₂FCHF₂, trifluorochloropropane, 1-fluoro-1,1-dichloroethane, 1,1,1-trifluoro-2,2-dichloroethane, methylene chloride, diethyl-ether, isopropyl ether, methyl formate, carbon dioxide and mixtures thereof.

The foams also can be produced using a froth-foaming method, such as the one disclosed in U.S. Pat. No. 4,572,865. In this method, the frothing agent can be any material which is inert to the reactive ingredients and is easily vaporized at atmospheric pressure. The frothing agent advantageously has an atmospheric boiling point of −50° to 10° C., and includes carbon dioxide, CF₃CH₂F (HFC-1349), CHCIF₂ (HCFC-22) and the like. A higher boiling blowing agent is desirably used in conjunction with the frothing agent. The blowing agent is a gaseous material at the reaction temperature and advantageously has an atmospheric boiling point ranging from about 10° to 80° C. Suitable blowing agents include acetone, pentane, and the like.

The foaming agents, e.g., blowing agent or combined blowing agent and frothing agent are employed in an amount sufficient to give the resultant foam the desired core density which is generally between 0.5 and 10, preferably between 1 and 5, and most preferably between 1.5 and 2.5, pounds per cubic foot. The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at subambient temperatures until mixed with the other components. Mixtures of foaming agents can be employed.

Any suitable surfactant can be employed in the foams of this invention, including silicone/ethylene oxide/propylene oxide copolymers. Examples of surfactants useful in the present invention include, among others, polydimethylsiloxane-polyoxyalkylene block copolymers available from the Crompton Corporation under the trade names “L-5420” and “L-5100” and from the Dow Corning Corporation under the trade name “DC-193”, Tegostab B84PI (Goldschmidt), Y10714 (Compton Corp.) and Dabco DC9345 (Air Products). Other suitable surfactants are those described in U.S. Pat. Nos. 4,365,024 and 4,529,745. Typically, the surfactant comprises from about 0.05 to 10, and preferably from 0.1 to 6, weight percent of the foam-forming composition.

The catalyst added to the reaction mixture is a compound capable of catalyzing the polymerization reaction. Such catalysts are known, and the choice and concentration thereof is within the purview of a person skilled in the art. Non-limiting examples of suitable catalysts include tertiary amines and/or organometallic compounds. Suitable tertiary amine catalysts include dimethylcyclohexylamine, bis(dimethylaminoethyl)ether, tetramnethylhexane diamine, triethylenediamine, N-methylmorpholine, pentamethyldiethylenetriamine, tetramethylethylenedianine, 1-methyl-4-dimethylaminoethylpiperazine, 3-methoxy-N-dimethylpropylamnine, N-ethylmorpholine, diethylethanolamine, N-cocomorpholine, N,N-dimethylyl-N′, N′-dimethyl isopropylpropylenediamine, N,N-diethyl-3-diethylaminopropylamine, dimethylbenzylamine (for example, Polycat 8, 9, 5 43, BL11, BL17, Dabco T, DMP30, TMR, all available from Air Products and Niax Al, A99, A107, all available from Union Carbide), organometalic catalysts, k-octalate, k-acetate, and blends with amines. Preferred amine catalysts include Polycat 5, and Polycat 43.

The filler that is typical utilized with a thermoset polymer may have a particle size distribution in the range of submicron particles to sizes as large as 200 microns, and more particularly range from about 10 nanometers to 100 microns. The fillers may be selected from the group of fillers including aluminum hydrates, alkaline earth carbonates, such as calcium carbonates ammonium phosphate, barium phosphate or magnesium carbonates, ammonium phosphate, barium phosphate, bentonite, hydroxides, fly ash, etc. Particularly useful in the present invention are aluminum trihydrate and carbon black. The relative proportion and size of the filler to be employed is within the purview of the skilled artisan fabricating the foam.

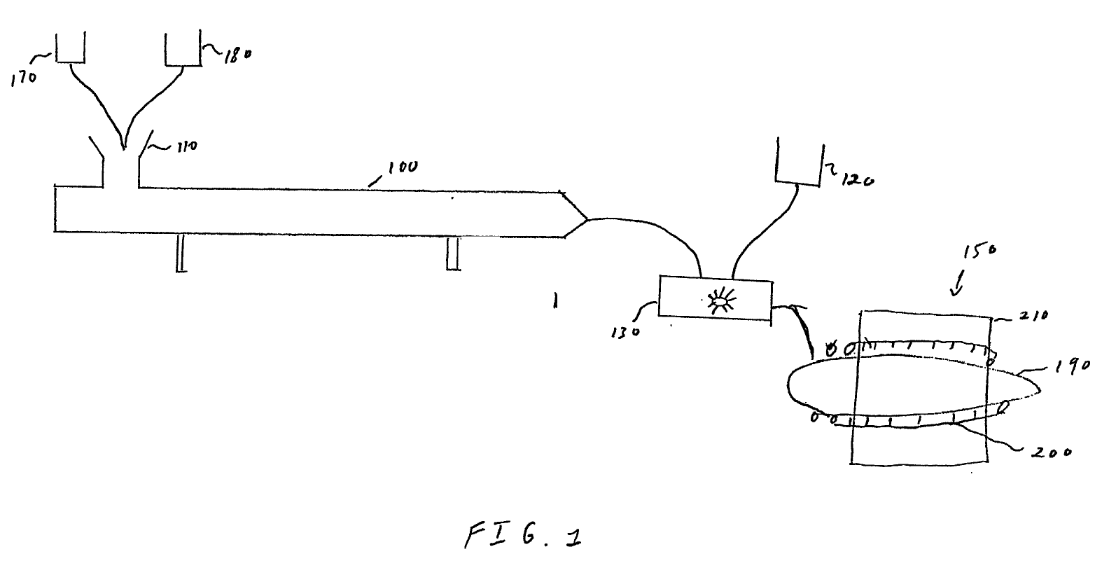

With reference to FIG. 1, an A-component solution is prepared and provided to a reservoir 170 having a large capacity, preferably a 30 gallon capacity. A suspension of filler particles may be fed into to reservoir 170 or optionally the filler particles can be provided directly to the upstream end of extruder 100 through hopper 110. The B-component solution is mixed with foaming agent in a Lightening mixer 180 and fed to the extruder through hopper 110.

The polyol and isocyanate containing filler particles (preferably, carbon black) are mixed and substantially dispersed in the extruder. Thereafter, the chemical stream is discharged though a die (not shown) at a downstream end of the extruder, and conveyed under pressure through a conduit to a mixing head 130.

A predetermined amount of catalyst, such as potassium octoate, is maintained in reservoir 120 and delivered to the mixing head or mixing heads through a conduit. The catalyst is metered and maintained under the requisite pressure by a pump, such as pneumatic or air driven pump. As the catalyst is delivered to mixing head 130 the foaming reaction is initiated.

Conveying/forming apparatus disposed below the mixing head 130 includes a an endless revolving conveyor belt 190 having lateral boundary members which form the contour of a mold. The reaction mixture discharged thereon does not change into a foamed or cellular condition immediately, but instead convert gradually over a period of about 5 to 300 seconds to a fully set cellular condition. Typically, after about 3 to 5 seconds the reaction mixture begins to cream, in which case it begins to expand. As the reaction mixture is discharged from the mixing head it is conveyed downstream. The foam passes between a pair of rolls which rotated in clockwise direction and then to a slat conveyor 200, through a heated area 210 where the foam rises. Optionally, the foam is introduced between upper and lower paper liners provided from spools of web or foil. The resultant product being a laminate insulation sheet.

Slat conveyors generally vary from 20-100 feet in length. The slat conveyor is heated to about 150° F. and is substantially contained in an enclosure to conserve energy. A typical apparatus of this type is described in U.S. Pat. No. 4,795,763, and it is hereby incorporated by reference.

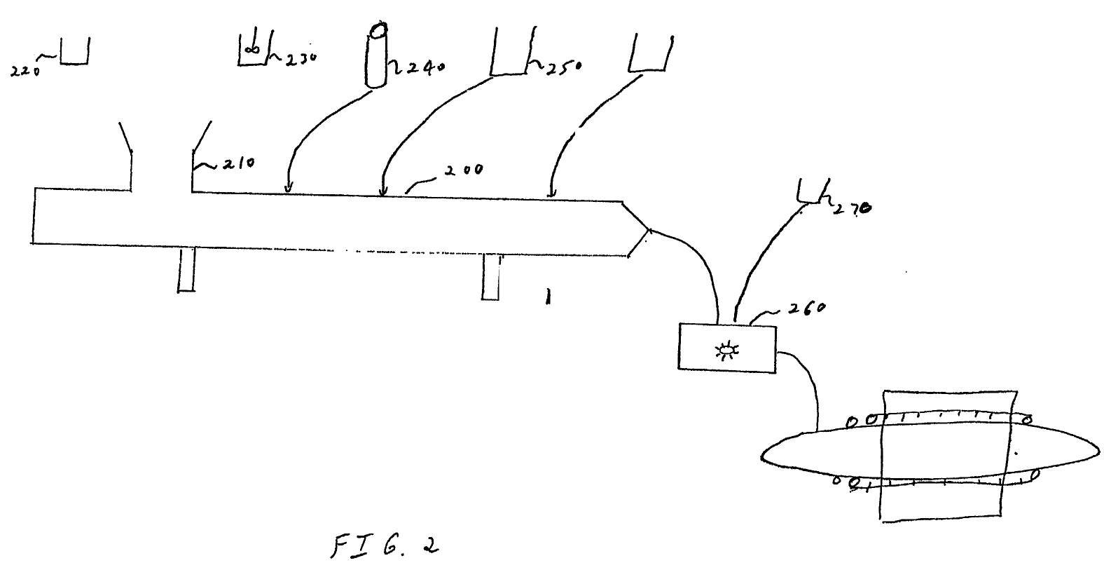

As illustrated in FIG. 2, the foam components, except the catalyst, are supplied sequentially to separate mixing section of an extruder. In the exemplary embodiment, an extruder 200 having at least four mixing sections is provided. A metered amount of filler particles is supplied form reservoir 220 to hopper 210, upstream on the extruder in mixing section A. Likewise, a premix of polyol and surfactant is supplied from mixer 230 to the extruder screw in this first mixing section. The remainder of the polyol is added from reservoir 240, where the remainder of the polyol may be optionally mixed with filler, preferably carbon black, in a second mixing zone downstream of the first. Isocyanate is fed from reservoir 250 and fed into a third mixing zone where it is mixed with the ingredients already in the extruder. In this embodiment, a blowing agent is added in a fourth mixing zone downstream from the third one, where mixing and homogenizing takes place.

The chemical stream obtained is discharged into mixing head 260 to which a catalyst, such as potassium octoate, is provided in a metered amount from reservoir 270. The reaction mixture is subsequently discharged on a conveyor apparatus, such as the one discussed above, where the foam expands and cures in the desired shape.

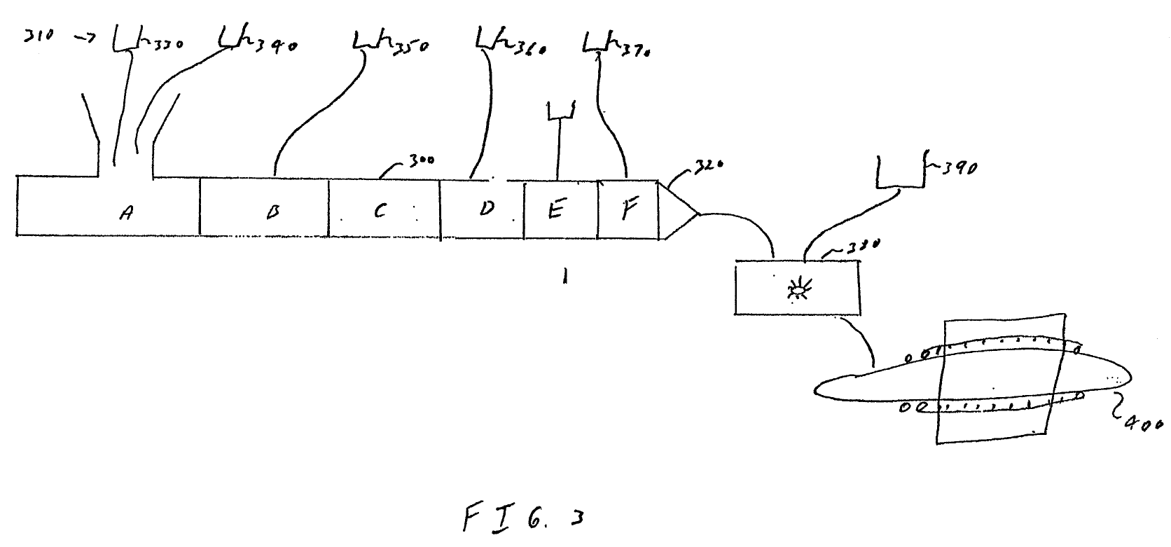

With reference to FIG. 3, a third embodiment suitable for practicing the invention is illustrated. The apparatus includes a single or twin screw extruder 300 and an reservoir system 310. The extruder includes a series of mixing sections A-F and an extruder head 320. The reservoir system 310 includes a plurality of reservoirs 330-370 from which foam components are supplied.

The reservoirs 330-370 feed the foam components materials to mixing sections A-F of extruder 300 via feed lines and metering pumps.

In manufacturing a isocyanurate foam, filler material is provided to extruder 300 from reservoirs 330 and 340. Isocyanate solution is mixed and fed to mixing sections to mixing section B and D of extruder 300 through reservoirs 350 and 360.

The isocyanate solution may be optionally mixed with a dispersing agent and/or surfactant. Surfactant may be optionally mixed with a dispersing agent and provided to extruder 300 with isocyanate and dispersing agent at mixing sections B and D.

Polyol is preferably provided from reservoir 370 and fed to the extruder at mixing section F. Foaming agent is provided to the extruder E without mixing with other components. Additionally, foaming agent may be mixed with polyol at reservoir 370 prior to entry at mixing section F. In other words, foaming agent is first mixed with polyol and provided to extruder 300 at mixing section F after the foaming agent is first mixed with polyol/surfactant mixture. The chemical stream discharged from extruder 300 is conveyed to mixing head 380 to which a catalyst in a metered amount from reservoir 390. The reaction mixture is then discharged on a conveyor apparatus 400, where the foam is cured as described above.

Alternatively, the isocyanate and polyol solutions are prepared in separate extruders and the separate chemical streams are subsequently fed to a mixing head.

While the invention has been described in detail with reference to specific embodiments thereof, it will be apparent to those skilled in the art that various changes and modifications can be made, and equivalents employed, without departing from the scope of the appended claims.

What is claimed is:

1. An apparatus for continuously manufacturing a thermoset polymer foam, comprising:
at least one extruder for metering at least one chemical stream;
a mixing head for continuously receiving and mixing at least two chemical streams, at least from said extruder;
a conduit connected to the mixing head to supply a metered amount of catalyst; and
a conveyor disposed below to receive a substantially homogeneous reacting chemical liquid from said mixing head, wherein said conveyor includes a frame defining a mold.

2. The apparatus according to claim 1, comprising an extruder for each chemical stream forming the foam.

3. The apparatus according to claim 1, wherein said extruder supplies said chemical stream based on volumetric quantity.

4. The apparatus according to claim 1, wherein said at least one chemical extruder is a reciprocating screw extruder.

5. The apparatus according to claim 1, wherein said at least one chemical extruder is a twin-screw extruder.

6. The apparatus according to claim 1, further comprising a pump disposed in said conduit to supply the catalyst.

7. The apparatus according to claim 1, wherein the conveyor is an endless revolving conveyor belt having lateral boundary members over the upper run of the belt for limiting lateral movement of the reacting chemical liquid.

8. The apparatus according to claim 1, further comprising at least one spool of web or foil placed connected to the conveyor to place a said foil between the conveyor and the reacting chemical liquid.

9. A method for continuously preparing a thermosetting polymer foam, comprising:
introducing polyol into an extruder barrel;
introducing an isocyanate into said extruder barrel;
introducing filler particles into said extruder barrel;
introducing a foaming agent into said extruder barrel;
mixing said polyol with said isocyanate, said filler particles and said foaming agent in said extruder to form a chemical mixture;
metering and supplying said chemical mixture to a mixing head; and
introducing a catalyst to said mixing head, thereby reacting the isocyanate and polyol and initiating a foaming reaction.

10. The method according to claim 9, wherein the filler particles are selected from the group consisting of carbon black, aluminum trihydrade, perlite, polyiso powders, ammonium phosphate, fly ash diatomaceous earth, calicium silicate, barium silicate, melamine, and calcium carbonate.

11. The method according to claim 9, further comprising mixing a surfactant with said isocyanate to form a surfactant/isocyanate mixture and introducing said surfactant/isocyanate mixture to said extruder barrel.

12. The method according to claim 9, further comprising mixing said foaming agent with said polyol to form a foaming agent/polyol mixture and thereafter introducing the mixture to said extruder barrel.

13. The method according to claim 11, wherein the surfactant/isocyanate mixture is provided to said extruder barrel is prepared in a separate extruder.

14. The method according to claim 12, wherein the foaming agent/polyol mixture is provided to said extruder barrel is prepared in a separate extruder.

15. The method according to claim 13, wherein said surfactant/isocyanate mixture is provided to a mixing head.

16. The method according to claim 14, wherein the foaming agent/polyol mixture is provided to the mixing head.

17. The method according to claim 9, wherein the foaming agent is selected from the group consisting of hydrochlorofluorocarbon (HCFC), HC, HFC, CFC, H₂O liquid CO₂, and mixtures thereof.

18. The method according to claim 9, further comprising receiving said foaming reaction on a conveyor disposed below said mixing head to allow the reaction to go to completion as the formed thermoset foam is further conveyed downstream.

19. The method according to claim 18, further comprising providing a web or foil between the foaming reaction and the conveyor.

20. The method according to claim 9, wherein said extruder is a twin screw extruder which is operated at 300 to 900 rpm.
